(19) United States
(12) Patent Application Publication
(10) Pub. No.: US 2019/0362034 A1
(43) Pub. Date: Nov. 28, 2019

(54) Design Method for Civil Engineering of Reality Scenery

(71) Applicant: Chun-Sheng Chiang, Sanxing Township (TW)

(72) Inventor: Chun-Sheng Chiang, Sanxing Township (TW)

(21) Appl. No.: 16/373,158

(22) Filed: Apr. 2, 2019

(30) Foreign Application Priority Data
May 28, 2018 (TW) 107118071
Nov. 14, 2018 (TW) 107140371

(51) Int. Cl. G06F 17/50; G06T 19/20; G06T 7/70

(52) U.S. Cl. CPC G06F 17/5004; G06T 19/20; G06T 7/70; G06T 2200/08; G06T 2219/2004; G06T 2207/30184; G06T 2219/2008; G06T 2219/2016; G06T 2207/10032

(57) ABSTRACT

A design method for civil engineering of reality scenery includes: selecting at least a reference point at a construction site, having a coordinate of the construction site defined as an absolute coordinate, establishing a three-dimensional (3D) model of a real scene, having a coordinate of the 3D model defined as a relative coordinate relative to the absolute coordinate of the construction site, calibrating the relative coordinate corresponding to the absolute coordinate and converting the relative coordinate into the absolute coordinate, incorporating virtual 3D objects into the 3D model, synchronously displaying the projected view of the 3D model as observed through a specific viewing angle, on a display device, and setting up a statistic database for synchronously recording the virtual 3D object as input into the 3D model or objects as removed from the 3D model, and outputting the statistic data from the statistic database through an output device.

### BACKGROUND OF THE INVENTION

In a conventional civil engineering design, a real survey should be conducted at the construction site. Then, a 3D design model may be obtained by drawings such as by AutoCAD, 3DMAX. In order to increase the scene ambiance (a feeling as attending the construction site) of the 3D model, some landscape elements or objects including street trees, mountainside, water ponds, or bridge may be added into the design features of the design model. However, such additions of landscape elements are drawn virtually (not in reality), which do not exist in the real environment. So, a design error or deviation from the real image may occur to cause disputes between the designer and his or her client.

In order to increase the reality for the scenery of the real construction site, an aerial photograph by satellite or drone is provided to form a 3D model. For example, Google SketchUP is provided to obtain landforms and image data on Google Earth, which are combined with 3D model, to be adapted for engineering design on the 3D model as established by the user or designer.

However, the image as taken by satellite or drone just reveals a relative coordinate corresponding to the absolute coordinate of the real construction site, to thus produce an error, especially an elevation error, between the relative coordinate and the absolute coordinate. Such an error may cause unprecise design and wrong estimation or calculation for the relevant data. As shown in FIG. 1, a curved surface f′ of a 3D model is obtained as taken by satellite or drone, having a relative coordinate x′, y′, z′ corresponding to an absolute coordinate of a curved surface f of a real construction site, having an absolute coordinate x, y, z. There exists an elevation difference between the two coordinates f′, f, such as Δz(Δz=z′−z, Δx=x′−x, and/or Δy=y′−y). If it is intended to dig an earth for forming a water pool at the construction site, a false earth volume of 6M length×6M width x (z−2+Δz) M depth defined among a, b′, c′ and d′ may be dug out because a relative coordinate along f′ of the 3D model is not calibrated and decompressed into the absolute coordinate along f at the real construction site. However, it is merely necessary to dig out an earth volume of 6M×6M (z−2) M as defined among a, b, c and d as shown in FIG. 1. Without a calibration or decompression of the relative coordinate along f′ into the absolute coordinate along f, an earth volume of 6M×6M×ΔzM will be dug out additionally to thereby waste construction cost. Therefore, such a conventional engineering design may cause a great error, being unable to have a precise design and also increasing cost accordingly.

For measuring an elevation or altitude of a building, a Digital Elevation Model (DEM) may be used by projecting light pulses towards a specific plan or terrain and then returning to a sensor in order to obtain matrix of elevation value. Another method of Digital Orthophoto Map (DOM) may obtain image through aerial scanning process or obtain image data as remotely sensed by a satellite. The image or image data is then subsequently calibrated for calibrating each pixel to thereby obtain an orthophoto image set comprised of scaled mappable units. However, such images are based on a relative coordinate, not an absolute coordinate of the real construction site. All image data obtained through DEM or DOM should be further integrated as 3D model by VRMap. However, it requires an overall scanning for obtaining elevation values or requires a scanning of the image data at the construction site, causing inconvenience for the construction, especially at a construction site of large area, which may make survey more difficult.

Moreover, the current method of engineering design may not input the statistic data into a statistic table whenever conducting the design work. The designer must manually calculate the relevant data and then input into the statistic table, which is quite time-consuming and may easily make errors during the designing and calculation.

The present inventor has found the drawbacks of the conventional design method, and invented the present novel and efficient method.

### SUMMARY OF THE INVENTION

The object of the present invention is to provide a design method for civil engineering of reality scenery comprising the steps of:
1. Demarcating or selecting at least a reference point at a construction site, having a coordinate of the construction site defined as an absolute coordinate;
2. Establishing a three-dimension (3D) model of a reality scenery by obtaining an image of the construction site through a camera, having a coordinate of the 3D model defined as a relative coordinate relative to the absolute coordinate of the construction site;
3. Calibrating the relative coordinate of the 3D model corresponding to the absolute coordinate of the construction site, and decompressing the relative coordinate of the 3D model into the absolute coordinate of the construction site;
4. Compiling or editing the 3D model of reality scenery by removing objects from the 3D model, incorporating a virtual 3D object into the 3D model, or modifying the virtual 3D object as added into the 3D model;
5. Synchronously displaying the projected view of the 3D model, as observed through a specific viewing angle, on a display device; and
6. Setting up a statistic database or table for synchronously recording the virtual 3D object as input into the 3D model or the objects as removed from the 3D model; and outputting a statistic data from the statistic database or table through an output device for further uses of the statistic data.

According to the present invention, the camera provided for establishing the 3D model of reality scenery may be a camera drone with a camera mounted on a drone or an unmanned aerial vehicle (UAV). The camera drone is wirelessly communicated with a signal emitter, which is installed at a reference point with an absolute coordinate of the real construction site, when flying along a relative coordinate of the 3D model. The relative coordinate is then calibrated, converted or decompressed into the absolute coordinate.

According to the present invention, a difference between the relative coordinate of the 3D model and the absolute coordinate at the reference point of the real construction site may be defined as a calibration value. An identical calibration value may be set up for calibrating the 3D coordinates of the 3D model in the whole area.

According to the present invention, there are plural reference points set up at the construction site. The relative coordinates of the 3D model may be corresponding to the plural reference points, and then calibrated and converted into the absolute coordinates of the construction site. The 3D model may be calibrated corresponding to plural reference points as set at the real construction site, and calibrated as based upon a smooth curved surface.

In the present invention, a survey map or drawing of the construction site is prepared to be adapted for comparison and calibration of the 3D model.

According to the present invention, the statistic table may include plural items of the virtual 3D object added into the 3D models or objects removed from the 3D model, for instance, description of item, unit, quantity, unit price, amount or total amount by multiplying the unit price with the quantity.

In the present invention, the display device may display projected view of 3D model and at least a 2D drawing and description, in which the projected view (perspective) and the 2D drawing and description, may be synchronously linked.

The 2D drawing and description may include plan view layout, partial sectional drawing, or partial enlarged view having size or dimension indicated thereon.

According to the present invention, the virtual 3D object as added into the 3D model may output, by an output device, the engineering drawings of elements having size or dimension indicated thereon. The engineering drawings may include front view, top view and side view thereof.

Since the 3D model has been calibrated to match the absolute coordinates at the reference points on the construction site, the designer may directly retrieve data from the 3D model after being calibrated. For example, the designer may obtain a correct data of elevation or the distance between two points, thereby being helpful for the precise cost estimation or calculation and for lowering the design or survey cost.

The display device may be a single display device or plural display devices as provided in this invention. The preferred embodiments of present invention may be further described hereinafter with reference to the accompanying drawings.

### BRIEF DESCRIPTION OF THE DRAWINGS

FIG. 1 shows a prior art illustrating the relative coordinates of aerial photographic images versus the absolute coordinates of construction site.

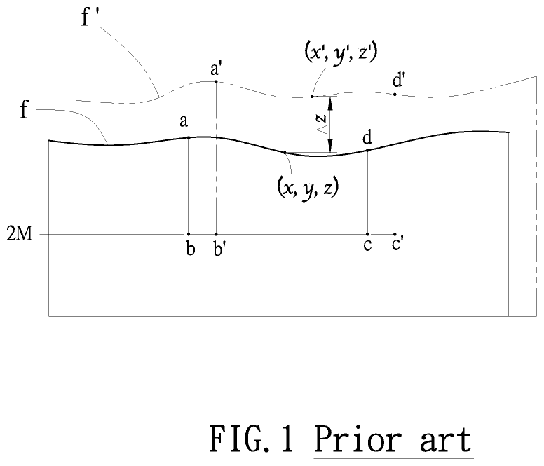

FIG. 2 shows a process flow sheet of the present invention.

FIG. 3 shows an illustration for calibrating the relative coordinates with the absolute coordinates the plural reference points on construction site.

FIG. 4 shows a calibration of the 3D model as established by a camera drone versus the reference points on the construction site.

### DETAILED DESCRIPTION

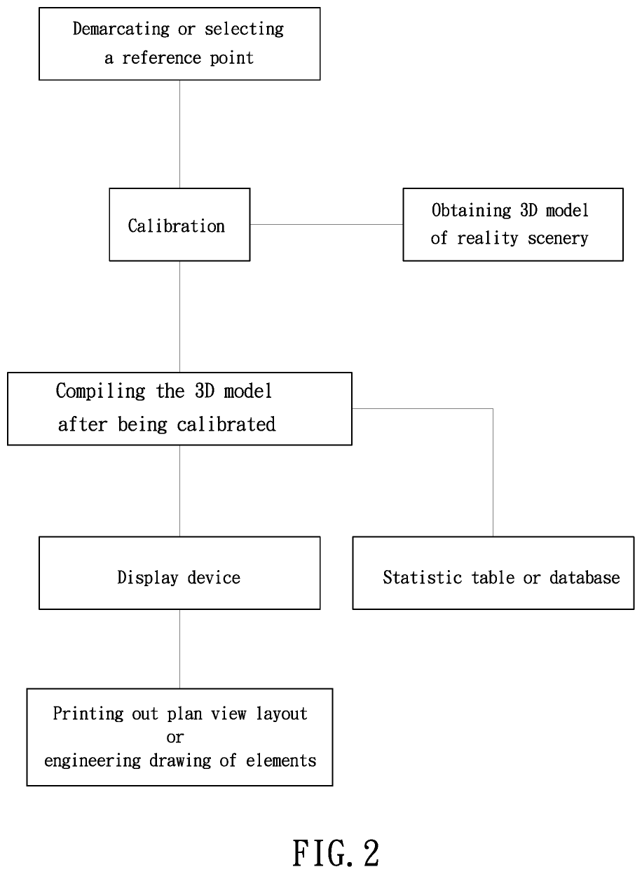

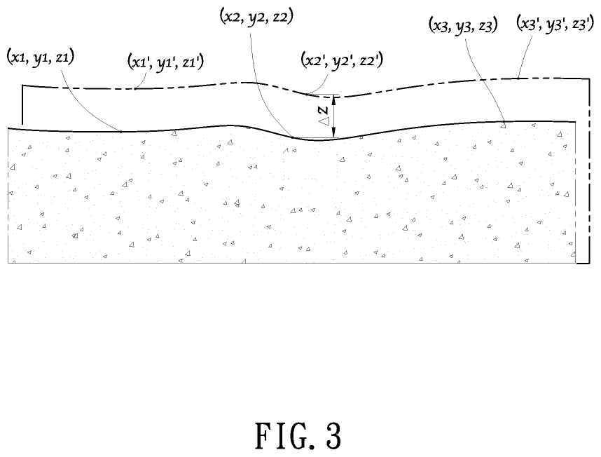

As shown in FIGS. 2-3, a design method for civil engineering of reality scenery of the present invention comprises the following steps:
1. Selecting or demarcating at least a reference point at a construction site: The coordinate of the construction site is defined as an absolute coordinate. For instance, a planar coordinate includes an abscissa of X-axis and an coordinate of Y-axis. An elevation of Z-axis is added to the planar coordinate to form a three-dimensional (3D) coordinate of x, y and z. As shown in FIG. 3, three absolute coordinate sets are exemplified, namely, (x1, y1, z1), (x2, y2, z2), and (x3, y3, z3).
2. Establishing a three-dimension (3D) model of a reality scenery by obtaining an image of the construction site through a camera including a digital camera based on a 3D relative coordinate of x′, y′, z′. As shown in FIG. 3, three relative coordinate sets are exemplified, namely, (x1′, y1′, z1′), (x2′, y2′, z2′), and (x3′, y3′, z3′). Such a relative coordinate x′, y′, z′ is relative to the absolute coordinate x, y, z at the reference point.
3. Calibrating the relative coordinate x′, y′, z′ of the 3D model corresponding to the absolute coordinate x, y, z at the reference point of construction site to decompress or convert the relative coordinate of the 3D model into the absolute coordinate of the construction site. Therefore, the relative coordinate x1′, y1′, z1′ will be decompressed or converted into the absolute coordinate x1, y1, z1. The relative coordinate x2′, y2′, z2′ will be converted into absolute coordinate x2, y2, z2. While the relative coordinate x3′, y3′, z3′ will be converted into absolute coordinate x3′, y3′ z3′.
4. Compiling or editing the 3D model of reality scenery by removing objects from the 3D model, incorporating virtual 3D object into the 3D model, or modifying the virtual 3D object as added into the 3D model.
5. Synchronously displaying the views of the 3D model of reality scenery including at least a projected view as observed through a specific viewing angle on a display device.
6. Setting up a statistic database or a table for synchronously recording the virtual 3D object as input into the 3D model or the objects as removed from the 3D model; and outputting the statistic data from the statistic database through an output device for further uses of the statistic data.

The reference point may be determined at the real construction site. A coordinate of the reference point may be obtained by survey, or may be retrieved from a national land administration or organization.

After calibration of the relative coordinate of the 3D model of reality scenery corresponding to the absolute coordinate at the reference point of the construction site, the coordinate of the 3D model will be precisely identical to the absolute coordinate at the reference point of the construction site. Therefore, the designer will obtain a precise distance or elevation (altitude) as measured between two points on the coordinates of 3D model after being calibrated. Such a precise measurement data is very helpful for calculating the cost of building materials and for obtaining a precise calculation for civil engineering design so as to lower the cost of survey, civil engineering design, time and other related costs. The present invention provides a convenient, time-saving, precise design and estimation or calculation method for civil engineering design.

The design method of the present invention may provide virtual 3D object, each virtual 3D object proportional to a true object with a ratio of 1:1, thereby well finishing the drawing or model. The real objects may refer to trees, walls, bridges, tiles, leisure chairs, fences, street lamps, pavilions, or any other landscapes, not limited in this invention.

After calibration of the relative coordinate of the 3D model to be corresponding to the absolute coordinate at the real construction site, the relative coordinate of the 3D model will be decompressed or converted into absolute coordinate of the real construction site, thereby substantially matching the relative coordinate of the 3D model with the absolute coordinate of the real construction site.

This is very important for civil engineering and construction. Accordingly, the elevation of the coordinate of 3D model is now converted to be identical to the elevation of the coordinate of the true construction site to thereby prevent or eliminate any elevation error between the relative coordinate of the 3D model and the absolute coordinate of the true construction site. If the relative coordinate is not calibrated and converted to match the absolute coordinate of the construction site, the architecture designer may not make a precise estimation or calculation, or quotation for the design and construction project. For example, an elevation of a 3D model is 5 meters, while the elevation of the true construction site is 4 meter to have a one-meter difference (or error) therebetween. Now, if a volume of earth of 6m×6m×2m must be dug out from the real construction site and the relative coordinate of the 3D model is not calibrated and converted into absolute coordinate of the construction site, a false data may be obtained to thereby dig out earth of 6m×6m×3m (108 m³) based upon the original data of relative coordinate of the 3D model. In a correct way to convert the relative coordinate of the 3D model into absolute coordinate of the real construction site, it needs to dig the earth volume of 6m×6m×2m (72 m³) only, thereby saving the digging volume of 36 m³ (108 m³−72 m³) and saving the digging cost form the total construction cost. The calibration may cover three dimensional calibrations and two dimensional calibration. The calibration includes planar coordinate calibration and also the elevation (or altitude) calibration. This may solve the problem of a conventional design method, by which the coordinate of 3D model does not match the coordinate of the real construction site to cause design error between the 3D model and the real construction site.

As shown in FIG. 3, the relative coordinates, namely, (x1′, y z1′), (x2′, y2′, z2′) and (x3′, y3′, z3′) of the 3D model will be calibrated and decompressed into absolute coordinates, namely, (x1, y1, z1), (x2, y2, z2) and (x3, y3, z3) of the real construction site. A curved surface of the 3D model, as corresponding to a curved surface the real construction site as defined among plural reference points, may be calibrated as based up on “smooth curved surface”.

A calibration value may be defined in this invention to be a difference value between the relative coordinate of the 3D model and the corresponding absolute coordinate of the real construction site. For example, taking Z-axis as an example, a difference value, Δz=z1′−z1 may be deemed as a calibration value between the relative coordinate and the absolute coordinate. Then, the relatives coordinate of the 3D model can be calibrated corresponding to the absolute coordinate by such a calibration value. The calibration value can be identical for the whole area of the construction site.

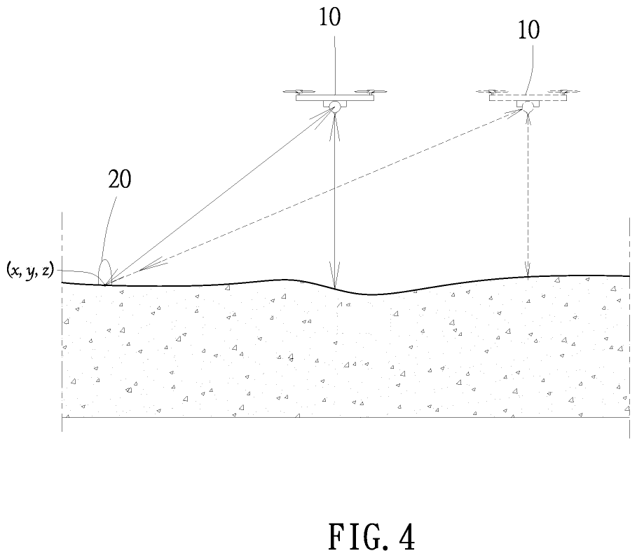

As shown in FIG. 4, a camera drone (or drone mounted with camera) 10 is provided for establishing a 3D model of reality scenery. A signal emitter 20 is installed at a reference point with a coordinate x, y, z. The camera drone 10 is wirelessly communicated with the signal emitter 20 when flying along the relative coordinates of the 3D model. By the way, the camera drone 10 will establish the 3D model with relative coordinates and synchronously calibrate the relative coordinates of the 3D model corresponding to the absolute coordinates of reference points of the real construction site, thereby decompressing or converting the relative coordinates of the 3D model into the absolute coordinates of the real construction site in order to save time and cost for establishing and calibrating the 3D model.

The present invention further comprises preparation of a survey map at the construction site. Such a survey map may be drawn at the construction site through actual survey, measurement and drawing. Or, the survey map may be retrieved from a cadastral map or a land registration map as stored in a governmental land administration. Such a survey map may be served for calibrating the 3D model when mutually compared at the same viewing angle. Then, the 3D model will match the survey map for a reliable land identification.

The statistic database including statistic table, a list of virtual 3D object as added into the 3D model, and/or of the objects removed from the 3D model, also including units, quantity, unit price, amount or total amount thereof.

An example list is given as follows:

| | | | | Amount |
|---|---|---|---|---|
| Items | Unit | Quantity | Unit price | (Dollars) |
| Leisure chairs | set | 2 | 100 | 200 |
| Fences | M | 200 | 5 | 1,000 |
| Earth Dug and | M³ | 1,500 | 7 | 10,500 |
| Removed | | | | |
| Total | | | | 11,700 |

The above-listed data are merely served as an example. All items and descriptions are not limited in the present invention.

According to the present invention, the statistic database (or table) may record the synchronous dynamic changes of the virtual 3D object as added into the 3D model or the objects as removed from the 3D model.

The display device of the present invention may simultaneously display any projections (views) of the 3D model and also 2D drawing and description of the construction project on the display device. The synchronous dynamic changes of the projected view (perspective/parallel projection) and the 2D drawing and description of construction project may also be displayed on the display device simultaneously. The perspective view and the top view of the 3D model of reality scenery may be displayed on the display device. During the compiling of the 3D model, the projected view (Perspective/parallel projection) and 2D drawing and description as well as the data in statistic database are also dynamically synchronously linked corresponding to the compiling of the 3D model. The above-mentioned display devices may be a single device or plural display devices, not limited in this invention.

The above-mentioned 2D drawing and description of the construction project may refer to the plan view drawing having dimension or description indicated thereon, sectional drawing or enlarged view thereof. Such data may be output as a construction instruction or reference of the construction contractor.

The display device of the present invention may output the virtual 3D object including dimension indication and description of the engineering drawing of the elements. Such engineering drawing may include the front view, top view and side view of the virtual 3D object.

The present invention has the following advantages superior to the conventional engineering design methods:
1. The calibrated coordinates of the 3D model of reality scenery are matching the absolute coordinates of the real construction site, indicating close to no error between the coordinate of the 3D model and the real construction site.
2. The designer may directly retrieve any distance or elevation data between any two points from the 3D model since the distance or the elevation is identical to the value of actual survey or measurement from the construction site, thereby being beneficial for a precise calculation or estimation of the civil engineering design.
3. A combination of statistic table, 2D drawing and description records all data of the materials, building materials of virtual 3D object in the statistic table so that the designer may instantly retrieve or obtain the desired data directly from the statistic record of the statistic table (database), without further manual calculation.
4. Upon compiling of the 3D model, a view drawing or view drawings through plural viewing angles may be synchronously displayed to thereby help the designer conveniently observe or check his or her design results.

The present invention may be further modified without departing from the spirit and scope of the present invention.

What is claimed is:

1. A design method for civil engineering of reality scenery comprising the steps of:
(1) Demarcating or selecting at least a reference point at a construction site, having a coordinate of the construction site defined as an absolute coordinate;
(2) Establishing a three-dimension (3D) model of a reality scenery by obtaining an image of the construction site through a camera drone having a coordinate of the 3D model defined as a relative coordinate relative to the absolute coordinate of at least a reference point at the construction site;
(3) Calibrating the relative coordinate of the 3D model corresponding to the absolute coordinate of the construction site, and decompressing or converting the relative coordinate of the 3D model into the absolute coordinate of the construction site;
(4) Compiling or editing the 3D model of reality scenery by removing objects from the 3D model, incorporating virtual 3D object into the 3D model, or modifying the virtual 3D object as added into the 3D model.
(5) Synchronously displaying the projected view of the 3D model, as observed through a specific viewing angle, on a display device; and
(6) Setting up a statistic database or table for synchronously recording the virtual 3D object as input into the 3D model or the objects as removed from the 3D model; and outputting the statistic data from the statistic database through an output device for further uses of the statistic data.

2. A method according to claim 1, wherein said camera drone, when flying, is wirelessly communicated with a signal emitter installed at the reference point for obtaining and calibrating the 3D relative coordinates of the 3D model to be converted or decompressed into the absolute coordinates of the real construction site.

3. A method according to claim 1, wherein said design method further comprises defining a calibration value which is a difference value between the relative coordinate of the 3D model and the absolute coordinate at the reference point on the construction site; said calibration value being an identical calibration value adapted for calibrating 3D coordinates in the whole area.

4. A method according to claim 1, wherein said construction site is set up plural reference points and the 3D model is calibrated with said construction point with reference to the plural reference points, as based upon a smooth curved surface.

5. A method according to claim 1, wherein said design method further comprises providing a survey map or drawing of the construction site, to be compared with the 3D model, and served as a reference for calibrating the 3D model.

6. A method according to claim 1, wherein the statistic database or table comprises the description of items of virtual 3D object added into the 3D model or the objects removed from the 3D model, the items further including: units, quantity, unit price, amount, and total amount, wherein the amount is obtained by multiplying the unit price with the quantity.

7. A method according to claim 1, wherein said display device simultaneously displays projected view of the 3D model, and at least a 2D construction drawing and description, said projected view and said 2D drawing and description are synchronously linked.

8. A method according to claim 7, wherein said 2D drawing and description comprises the plan view layout, sectional drawing or enlarged view, having size or dimension or description shown thereon.

9. A method according to claim 7, wherein said projected view, 2D construction drawing and description, and a statistic table are synchronously linked.

10. A method according to claim 1, wherein said virtual 3D object of said 3D model operatively output by said output device the virtual 3D object including engineering drawings of elements having size or dimension or description indicated thereon.
